(19) United States
(12) Patent Application Publication
(10) Pub. No.: US 2021/0363298 A1
(43) Pub. Date: Nov. 25, 2021

(54) SEPARATING A DOUBLE METAL CYANIDE CATALYST

(71) Applicant: Covestro Intellectual Property GmbH & Co. KG, Leverkusen (DE)

(72) Inventors: Thomas Ernst Mueller, Bochum (DE); Michael Pohl, Aachen (DE)

(21) Appl. No.: 17/051,340

(22) PCT Filed: May 6, 2019
(86) PCT No.: PCT/EP2019/061590

§ 371 Date: Oct. 28, 2020

(30) Foreign Application Priority Data
May 8, 2018 (EP) 18171360.3

(51) Int. Cl. C08G 65/30; C08G 65/26

(52) U.S. Cl. CPC C08G 65/30; C08G 65/2663

(57) ABSTRACT

A method for separating a double metal cyanide catalyst (DMC catalyst) from polyol, comprising: A) initially charging a polyol comprising DMC catalyst, an alcohol, and optionally a filtration aid into a reactor, the mixture being heated, B) filtering the mixture from step A), and C) optionally separating the alcohol from the filtrate of step B), wherein in step A), as the alcohol, 4% by weight to 12% by weight of ethanol, based on 100% by weight of polyol, without a chelating agent is used.

### CROSS REFERENCE TO RELATED APPLICATIONS

This application is a U.S. national stage application, filed under 35 U.S.C. § 371, of International Application No. PCT/EP2019/061590, which was filed on May 6, 2019, and which claims priority to European Patent Application No. 18171360.3, which was filed on May 8, 2018. The contents of each are incorporated by reference into this specification.

### FIELD

The present invention relates to a method for separating a double metal cyanide catalyst (also referred to as DMC catalyst hereinafter) from polyols.

### BACKGROUND

DMC catalysts are used in the preparation of polyols, such as for example polyether polyols or polyether carbonate polyols. These catalysts exhibit a high efficiency in the polymerization, as a result of which the proportion of catalyst used can be kept low. Despite the low proportion of DMC catalyst in the polyol, the storage stability of CO₂-containing polyols is lowered by residues of active DMC catalyst in the polyol. For this reason, and also because the DMC catalyst includes metal compounds such as for example cobalt compounds in its composition, separation is desirable.

A common method for separating the DMC catalyst from the polyol is filtration, wherein the DMC catalyst is converted into an insoluble state in a preceding step. Patent specification U.S. Pat. No. 5,416,241 discloses the use of alkali metal hydroxides, water and magnesium silicate for this preceding step. U.S. Pat. No. 5,099,075 describes the separation of the DMC catalyst by oxidation thereof with, for example, hydrogen peroxide, and subsequent filtration. In U.S. No. 5,248,833, an alcohol is used in combination with an acidic chelating agent in order to subsequently filter the DMC catalyst.

The use of such reactive compounds is undesirable for safety-relevant, environmental and economical aspects and can also have negative effects on the polyol. For example, the use of alkali metal salts in polyether carbonate polyols can lead to cleavage of the carbonate group in the polyether carbonate polyol and thus broaden the molecular weight distribution of the polyether carbonate polyol.

In EP 0 385 619 A2, the DMC catalyst is rendered insoluble by addition of a nonpolar solvent and is subsequently filtered. However, in EP 0 385 619 A2, at least 50% by weight, based on the polyol, of a nonpolar solvent is used. The use and subsequent separation of these amounts of solvents is uneconomical, however.

### SUMMARY

The object of the present invention is therefore that of providing an economical method for separating off a DMC catalyst without using a chelating agent, which results in insignificant changes, if any, to the polyol.

Surprisingly, this object has been achieved by a method for separating a double metal cyanide catalyst (DMC catalyst) from polyol, comprising the steps of
A) initially charging a polyol containing DMC catalyst, an alcohol and optionally a filtration aid into a reactor, the mixture being heated,
B) filtering the mixture from step A),
C) optionally separating the alcohol from the filtrate of step B),
characterized in that
in step A), as alcohol, 4% by weight to 12% by weight of ethanol, based on 100% by weight of polyol, without a chelating agent is used.

The steps performed in the method according to the invention are described in more detail hereinafter.

### DETAILED DESCRIPTION

### Step A)

The polyol containing DMC catalyst is a polyether polyol, polyether ester polyol, polyether carbonate polyol or a mixture of the aforementioned compounds. The polyol is preferably a polyether carbonate polyol.

Polyether carbonate polyols are prepared by addition of alkylene oxide and carbon dioxide onto an H-functional starter compound in the presence of a DMC catalyst, preferably by the steps of:
(α) initially charging a portion of the H-functional starter compounds and/or suspension medium not containing any H-functional groups into a reactor, in each case together with DMC catalyst, and optionally removing water and/or other volatile compounds by means of elevated temperature and/or reduced pressure (“drying”),
(β) activating the DMC catalyst by adding a portion (based on the total amount of alkylene oxide employed in the activation and copolymerization) of alkylene oxide to the mixture resulting from step (α), wherein this adding of a portion of alkylene oxide may optionally be performed in the presence of CO₂ and wherein the temperature spike (“hotspot”) which occurs due to the exothermic chemical reaction that follows and/or a pressure drop in the reactor is in each case awaited, and wherein step (β) for effecting activation may also be performed repeatedly,
(γ) adding alkylene oxide and carbon dioxide to the mixture resulting from step (β), where the alkylene oxide used in step (β) may be identical to or different from the alkylene oxide used in step (γ) and where H-functional starter compounds and DMC catalyst are optionally metered into the reactor continuously during the addition reaction.

The term “continuously” as used here can be defined as a mode of addition of a reactant such that a concentration of the reactant effective for the copolymerization is maintained, meaning that, for example, the metered addition can be effected with a constant metering rate, with a varying metering rate or in portions.

In general, for preparation of a polyether carbonate polyol, alkylene oxides (epoxides) having 2 to 24 carbon atoms may be used. The alkylene oxides having 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. The alkylene oxides used are preferably ethylene oxide and/or propylene oxide and/or 1,2-butylene oxide, particularly preferably propylene oxide.

Suitable H-functional starter compounds that may be used include compounds having hydrogen atoms which are active in respect of alkoxylation. Groups active in respect of alkoxylation and having active hydrogen atoms are, for example, —OH, —NH₂ (primary amines), —NH— (secondary amines), —SH and —CO₂H, preferably —OH and —NH₂, particularly preferably —OH.

Monofunctional starter compounds used may be alcohols, amines, thiols, and carboxylic acids. Monofunctional alcohols that may be used include: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, t-butylamine, pentylamine, hexylamine, aniline, aziridine, pyrrolidine, piperidine, morpholine. Monofunctional thiols that may be used include: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter compounds are dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol, octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these aforementioned alcohols having different amounts of ε-caprolactone. In mixtures of H-functional starter compounds, it is also possible to use trihydric alcohols, for example trimethylolpropane, glycerol, trishydroxyethyl isocyanurate and castor oil.

The H-functional starter compounds can also be selected from the substance class of the polyether polyols, in particular those having a molecular weight Mₙ in the range from 100 to 4000 g/mol, preferably from 250 to 2000 g/mol. Preference is given to polyether polyols constructed from repeating ethylene oxide and propylene oxide units, preferably having a proportion of propylene oxide units of from 35% to 100%, particularly preferably having a proportion of propylene oxide units of from 50% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®, Acclaim®, Arcol®, Baycoll®, Bayfill®, Bayflex®, Baygal®, PET® and Polyether polyols from Covestro Deutschland AG (e.g. Desmophen® 3600Z, Desmophen® 1900U, Acclaim® Polyol 2200, Acclaim® Polyol 4000I, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Examples of further suitable homopolyethylene oxides are the Pluriol® E brands from BASF SE, examples of suitable homopolypropylene oxides are the Pluriol® P brands from BASF SE, examples of suitable mixed copolymers of ethylene oxide and propylene oxide are the Pluronic® PE or Pluriol® RPE brands from BASF SE.

The H-functional starter compounds can also be selected from the substance class of the polyester polyols, in particular those having a molecular weight Mₙ in the range from 200 to 4500 g/mol, preferably from 400 to 2500 g/mol. The polyester polyols used are at least difunctional polyesters. Polyester polyols preferably consist of alternating acid and alcohol units. Examples of acid components used are succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Examples of alcohol components used are ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Using dihydric or polyhydric polyether polyols as alcohol components gives polyester ether polyols which can likewise serve as starter compounds for preparing the polyether carbonate polyols. If polyether polyols are used to prepare the polyester ether polyols, preference is given to polyether polyols having a number-average molecular weight Mₙ of 150 to 2000 g/mol.

In addition, the H-functional starter compounds used may be polycarbonate polyols (for example polycarbonate diols), especially those having a molecular weight Mₙ in the range from 150 to 4500 g/mol, preferably 500 to 2500, which are prepared for example through the reaction of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. For example, the polycarbonate diols used may be the Desmophen® C products from Covestro Deutschland AG, for example Desmophen® C 1100 or Desmophen® C 2200.

Polyether polyols used in accordance with the invention are obtained by preparation methods known to those skilled in the art, for example by anionic polymerization of one or more alkylene oxides having 2 to 24 carbon atoms using at least one H-functional starter compound containing 2 to 8, preferably 2 to 6, reactive hydrogen atoms in bonded form.

Suitable alkylene oxides and H-functional starter compounds that may be used are the compounds already described.

Usable polyether ester polyols are compounds containing ether groups, ester groups and OH groups. Organic dicarboxylic acids having up to 12 carbon atoms are suitable for preparing the polyether ester polyols, preferably aliphatic dicarboxylic acids having 4 to 6 carbon atoms or aromatic dicarboxylic acids used individually or in a mixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. In addition to organic dicarboxylic acids, derivatives of these acids can also be used, for example their anhydrides and also their esters and monoesters with low molecular weight monofunctional alcohols having 1 to 4 carbon atoms. The use of proportions of the aforementioned bio-based starting materials, especially of fatty acids or fatty acid derivatives (oleic acid, soybean oil, etc.) is likewise possible.

A further component used for preparing polyether ester polyols is polyether polyols, which can be obtained as has already been described.

Polyether ester polyols may also be prepared by the alkoxylation, in particular by ethoxylation and/or propoxylation, of reaction products obtained by the reaction of organic dicarboxylic acids and their derivatives and components with Zerewitinoff-active hydrogens, in particular diols and polyols. Derivatives of these acids that may be used include, for example, their anhydrides, for example phthalic anhydride.

Processes for preparing the polyols have been described for example by Ionescu in “Chemistry and Technology of Polyols for Polyurethanes”, Rapra Technology Limited, Shawbury 2005, p. 55 ff. (chapt. 4: Oligo-Polyols for Elastic Polyurethanes), p. 263 ff. (chapt. 8: Polyester Polyols for Elastic Polyurethanes) and in particular on p. 321 ff. (chapt. 13: Polyether Polyols for Rigid Polyurethane Foams) and p. 419 ff. (chapt. 16: Polyester Polyols for Rigid Polyurethane Foams). It is also possible to obtain polyester polyols and polyether polyols by glycolysis of suitable polymer recyclates.

Suitable suspension media are all polar aprotic, weakly polar aprotic and nonpolar aprotic solvents, containing no H-functional groups in each case. Suspension media used may also be a mixture of two or more of these suspension media. Mention is made by way of example at this point of the following polar aprotic solvents: 4-methyl-2-oxo-1,3-dioxolane (also referred to hereinafter as cyclic propylene carbonate or cPC), 1,3-dioxolan-2-one (also referred to hereinafter as cyclic ethylene carbonate or cEC), acetone, methyl ethyl ketone, acetonitrile, nitromethane, dimethyl sulfoxide, sulfolane, dimethylformamide, dimethylacetamide and N-methylpyrrolidone. The group of the nonpolar aprotic and weakly polar aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

DMC catalysts are known in principle from the prior art for the homopolymerization of epoxides (see, for example, U.S. Pat. Nos. 3,404,109, 3,829,505, 3,941,849 and 5,158,922). DMC catalysts described, for example, in U.S. Pat. No. 5,470,813, EP-A 700 949, EP-A 743 093, EP-A 761 708, WO-A 97/40086, WO-A 98/16310, and WO-A 00/47649 have very high activity in the homopolymerization of epoxides and make it possible to prepare polyether polyols and/or polyether carbonate polyols at very low catalyst concentrations (25 ppm or less). A typical example is the highly active DMC catalysts described in EP-A 700 949 which in addition to a double metal cyanide compound (e.g., zinc hexacyanocobaltate (III)) and an organic complex ligand (e.g., t-butanol) contain a polyether having a number-average molecular weight Mₙ of greater than 500 g/mol.

According to the invention in step A), as alcohol, ethanol is added to the polyol containing DMC catalyst in a proportion of 4% by weight to 12% by weight, based on 100% by weight of polyol. Preferably, the alcohol used in step A) is 5% by weight to 9% by weight of ethanol, based on 100% by weight of polyol.

A filtration aid is optionally provided in step A). Filtration aids are used for example to prevent clogging of the filter. Examples of filtration aids are cellulose, silica gel, aluminum oxide, activated carbon, kieselguhr or perlite.

The mixture is then heated in step A), preferably to a temperature of from 80 to 180° C., particularly preferably 80 to 120° C. The mixture in step A) is preferably heated for 100 to 140 min.

When preparing polyols in the presence of a DMC catalyst, the polyols are transferred into a postreactor after the reaction so that any remaining free alkylene oxide can react. In general, unreacted monomers or other volatile constituents are subsequently separated from the polyols by means of distillation. Accordingly, in a preferred embodiment of the present invention, step A) is carried out in such a postreactor in which alcohol and possibly filtration aids are added to the polyol containing DMC catalyst in the postreactor prior to distillation of the polyol.

### Step B)

The mixture resulting from step A) is subsequently filtered. Methods for filtration have been described, for example, by T. Sparks in “Solid-Liquid Filtration”, Butterworth-Heinemann, Oxford 2011. The mixture is preferably filtered through a depth filtration medium. The mixture resulting from step A) can in this case be filtered at a temperature of from 10 to 150° C., preferably 80 to 120° C. It is likewise possible to carry out the filtration under pressure, in this case a pressure of from 4 to 8 bar is preferably set.

### Step C)

Subsequent to the filtration in step B), the alcohol can be separated from the purified polyol by separation processes known to those skilled in the art. For the separation of the alcohol, thermal separation processes such as distillation or stripping or mechanical separation processes such as membrane filtration or dialysis may for example be used. Thermal separation processes or combinations of thermal and non-thermal separation processes may preferably be used for separating off the alcohol. Particular preference is given to using evaporation units, such as falling-film evaporators or vacuum evaporators, or stripping columns, and also combinations of these. Most preferably, a falling-film evaporator or thin-film evaporator is used in order to separate the alcohol from the purified polyol.

In a first embodiment, the invention relates to a method for separating a double metal cyanide catalyst (DMC catalyst), comprising the steps of
A) initially charging a polyol containing DMC catalyst, an alcohol and optionally a filtration aid into a reactor, the mixture being heated,
B) filtering the mixture from step A),
C) optionally separating the alcohol from the filtrate of step B),
characterized in that
in step A), as alcohol, 4% by weight to 12% by weight of ethanol, based on 100% by weight of polyol, without a chelating agent is used.

In a second embodiment, the invention relates to a method as per embodiment 1, characterized in that the polyol is a polyether polyol and/or a polyether carbonate polyol.

In a third embodiment, the invention relates to a method as per embodiment 1 or 2, characterized in that in step A) the alcohol used is 5% by weight to 9% by weight of ethanol.

In a fourth embodiment, the invention relates to a method as per any of embodiments 1 to 3, characterized in that in step A) the mixture is heated to a temperature of from 80° C. to 180° C.

In a fifth embodiment, the invention relates to a method as per any of embodiments 1 to 4, characterized in that in step A) the mixture is heated over a period of from 100 min to 140 min.

In a sixth embodiment, the invention relates to a method as per any of embodiments 1 to 5, characterized in that in step B) the filtration is carried out at a temperature of from 80° C. to 120° C.

In a seventh embodiment, the invention relates to a method as per any of embodiments 1 to 6, characterized in that in step B) the filtration is carried out at a pressure of from 4 bar to 8 bar.

In an eighth embodiment, the invention relates to a method as per any of embodiments 1 to 7, comprising the step of
C) separating the alcohol from the filtrate of step B).

In a ninth embodiment, the invention relates to a method as per embodiment 8, characterized in that the alcohol in step C) is separated off by an evaporation unit, a stripping column or a combination of these.

In a tenth embodiment, the invention relates to a method as per embodiment 9, characterized in that the evaporation unit is a falling-film evaporator or a thin-film evaporator.

In an eleventh embodiment, the invention relates to a method as per any of embodiments 1 to 10, characterized in that the polyol is a polyether carbonate polyol.

In a twelfth embodiment, the invention relates to a method as per embodiment 11, characterized in that the polyether carbonate polyol is prepared by addition of carbon dioxide and alkylene oxide onto an H-functional starter compound in the presence of a DMC catalyst, characterized by the steps of:
(α) initially charging a portion of the H-functional starter compound and/or suspension medium not containing any H-functional groups into a reactor, in each case together with DMC catalyst, and optionally removing water and/or other volatile compounds by means of elevated temperature and/or reduced pressure (“drying”),
(β) activating the DMC catalyst by adding a portion (based on the total amount of alkylene oxide employed in the activation and copolymerization) of alkylene oxide to the mixture resulting from step (α), wherein this adding of a portion of alkylene oxide may optionally be performed in the presence of CO₂ and wherein the temperature spike (“hotspot”) which occurs due to the exothermic chemical reaction that follows and/or a pressure drop in the reactor is in each case awaited, and wherein step (β) for effecting activation may also be performed repeatedly,
(γ) adding alkylene oxide and carbon dioxide to the mixture resulting from step (β), wherein the alkylene oxide used in step (β) may be identical to or different from the alkylene oxide used in step (γ) and where H-functional starter compounds and DMC catalyst are optionally metered into the reactor continuously during the addition reaction.

### Experimental

### Feedstocks

Polyol A polyether carbonate polyol, prepared via DMC-catalyzed polymerization of propylene oxide in the presence of CO₂ and having a functionality of 3, an OH number of 56.1 mg KOH/g, 12% by weight of incorporated CO₂ and a concentration of 200 ppm of DMC catalyst.

Ethanol ethanol denatured with 2% by weight of methyl ethyl ketone (from Fluka)

### General Experimental Procedure

A 300 ml pressure reactor was charged with 200 g of polyol A and ethanol was metered in (see table 1). The mixture was heated to the relevant temperature (see table 1) and stirred for 120 min (step A)). The mixture from step A) was subsequently withdrawn from the reactor and transferred into a pressurized suction filter for filtration. The mixture was filtered at 100° C. and 6 bar pressure through a Becopad® 450 filter layer (thickness: 3.9 mm, diameter: 50 mm, surface area: 157 mm², material: cellulose, retention range: 1.0 to 2.0 μm) from Eaton (step B)). The ethanol present in the filtrate was separated off in a subsequent step via a thin-film evaporator and the proportion of Co/Zn residues was ascertained (step C)). Detailed information regarding the proportions of ethanol used and the temperature used in step A) for the individual examples is given in table 1.

The proportion of DMC catalyst in the purified polyol A is determined by the Co/Zn residues present in the purified polyol A. The proportion of Co/Zn residue is determined by elemental analysis using inductively coupled plasma optical emission spectrometry (ICP-OES). The ICP-OES was carried out using a SPECTRO ARCOS from SPECTRO and an argon plasma. To determine the Co/Zn residues, the proportions for Co were determined via the emission at the wavelengths 228.616 nm, 230.786 nm and 238.892 nm, and the proportions for Zn were determined at 202.613 nm, 206.266 nm and 213.856 nm.

TABLE 1

| Examples | | 1* | 2* | 3* | 4* | 5 | 6* | 7 |
|---|---|---|---|---|---|---|---|---|
| Polyol A | % by | 100 | 100 | 100 | 100 | 100 | 100 | 100 |
| | weight | | | | | | | |
| Ethanol | % by | 0 | 1 | 3 | 79 | 7.3 | 3 | 7.3 |
| | weight ¹⁾ | | | | | | | |
| Temperature in | ° C. | 100 | 100 | 100 | 100 | 100 | 130 | 130 |
| step A) | | | | | | | | |
| Co/Zn | ppm | 19/40 | 15/32 | 7/15 | 14/28 | 2/5 | 9/19 | 4/9 |
| residues | | | | | | | | |

*Comparative example
¹⁾ based on the total weight of the polyol

Comparative example 1 in table 1 gives the proportion of the Co/Zn residues in polyol A after the method according to the invention, with no ethanol being added in step A). The method according to the invention in examples 5 and 7 leads to a marked reduction in the Co/Zn residues in the polyol component. In contrast, in comparative examples 2 to 4 and 6, amounts of ethanol that are not in accordance in the invention were added to the polyol component in step A). The proportion of Co/Zn residues in comparative examples 2 to 4 are markedly increased compared to example 5, those in comparative example 6 are markedly increased compared to example 7.

1. A method for separating a double metal cyanide catalyst (DMC catalyst) from polyol, comprising:
A) initially charging a polyol comprising a DMC catalyst, an alcohol, and optionally a filtration aid into a reactor, the mixture being heated,
B) filtering the mixture from step A), and
C) optionally separating the alcohol from the filtrate of step B),
wherein in step A), as the alcohol, 4% by weight to 12% by weight of ethanol, based on 100% by weight of polyol, without a chelating agent is used.

2. The method as claimed in claim 1, wherein the polyol is a polyether polyol and/or a polyether carbonate polyol.

3. The method as claimed in claim 1, wherein in step A) the alcohol used is 5% by weight to 9% by weight of ethanol.

4. The method as claimed in claim 1, wherein in step A) the mixture is heated to a temperature of from 80° C. to 180° C.

5. The method as claimed in claim 1, wherein in step A) the mixture is heated over a period of from 100 min to 140 min.

6. The method as claimed in claim 1, wherein in step B) the filtration is carried out at a temperature of from 80° C. to 120° C.

7. The method as claimed in claim 1, wherein in step B) the filtration is carried out at a pressure of from 4 bar to 8 bar.

8. The method as claimed in claim 1, comprising the step of
C) separating the alcohol from the filtrate of step B).

9. The method as claimed in claim 8, wherein the alcohol in step C) is separated off by an evaporation unit, a stripping column, or a combination of these.

10. The method as claimed in claim 9, wherein the evaporation unit is a falling-film evaporator or a thin-film evaporator.

11. The method as claimed in claim 1, wherein the polyol is a polyether carbonate polyol.

12. The method as claimed in claim 11, wherein the polyether carbonate polyol is prepared by addition of carbon dioxide and alkylene oxide onto an H-functional starter compound in the presence of a DMC catalyst, comprising the steps of:
(α) initially charging a portion of the H-functional starter compound and/or suspension medium not containing any H-functional groups into a reactor, in each case together with DMC catalyst, and optionally removing water and/or other volatile compounds by means of elevated temperature and/or reduced pressure (“drying”),
(β) activating the DMC catalyst by adding a portion, based on the total amount of alkylene oxide employed in the activation and copolymerization, of alkylene oxide to the mixture resulting from step (α), wherein this adding of a portion of alkylene oxide may optionally be performed in the presence of CO₂ and wherein the temperature spike (“hotspot”) which occurs due to the exothermic chemical reaction that follows and/or a pressure drop in the reactor is in each case awaited, and wherein step (β) for effecting activation may also be performed repeatedly,
(γ) adding alkylene oxide and carbon dioxide to the mixture resulting from step (β), where the alkylene oxide used in step (β) may be identical to or different from the alkylene oxide used in step (γ) and wherein H-functional starter compounds and DMC catalyst are optionally metered into the reactor continuously during the addition reaction.
